(19) United States
(12) Patent Application Publication
(10) Pub. No.: US 2009/0313866 A1
(43) Pub. Date: Dec. 24, 2009

(54) Novel holographic electric simulated flame generating device

(76) Inventor: Lieka WANG, Guangdong Province (CN)

Correspondence Address: Chan Yh, 42 Pin Oaks Drive, Phoenixville, PA, 19460, US

(21) Appl. No.: 12/432,764

(22) Filed: Apr. 30, 2009

(30) Foreign Application Priority Data
Jun. 23, 2008 (CN) 200820049831.8

(51) Int. Cl. G09F 19/12; G06F 17/00

(52) U.S. Cl. 40/428; 700/90

(57) ABSTRACT

A novel holographic electric simulated flame generating device, characterized in that it comprises a light-diffusing plate and an electric circuit board disposed behind the light-diffusing plate; a group of LED electronic scanning light source array which irradiates directly upon the light-diffusing plate is disposed on the electric circuit board; each LED light on the LED electronic scanning light source array is controlled by a controller. The present invention attains simulated flaming effects by a specially processed light-diffusing plate and programming control method. It has the advantages of being noiseless, low-voltage, low power consumption and low manufacturing costs. The present invention is relatively simple in structure and therefore may be made lighter and thinner and then applied to a simulated flame apparatus as a flame generating device. As a result, the practical applications of the present invention are more diverse and human-oriented. It is widely applicable to people's daily life according to the concept of the products, and could create planar simulated flames, curved simulated flames and even 360 degrees encompassing three-dimensional flaming effect according to people's needs.

### BACKGROUND OF THE INVENTION

The present invention relates to a simulated flame generating device.

Conventional simulated flame generating devices create a simulated flame by means of a mechanical rotating shaft to transmit flickering lights or by displacing objects by air current to attain a change in the light propagation path. As a result, light refracts upon different physical media along its traveling path and a visual effect resembling a real flame is produced. However, the simulated flame produced is only a planar image in both visual and sensual aspects, and the flaming effect produced is without three-dimensional sense. Besides, in practical applications, the mechanical rotational devices of these flame generating devices produce certain noise. Furthermore, due to the limitation of the mechanical rotational devices, whenever lights are refracted by physical media, transmission loss in the effective lights of image will be resulted, thereby increases the device imaging costs. Therefore, existing simulated flame generating devices have certain limitations in interior space, and they are difficult to be widely applicable.

### BRIEF SUMMARY OF THE INVENTION

An object of the present invention is to provide a novel holographic electric simulated flame generating device which is susceptible to low manufacturing costs and produces no noise, and attains visual effects resembling a real flame and is more human-oriented. The simulated flame produced has a stronger three-dimensional sense and an excellent sense of space and reality.

To solve the aforementioned technical problems, the present invention adopts the following technical proposal.

A novel holographic electric simulated flame generating device, characterized in that it comprises a light-diffusing plate and an electric circuit board disposed behind the light-diffusing plate; a group of LED electronic scanning light source array which irradiates directly upon the light-diffusing plate is disposed on the electric circuit board; each LED light on the LED electronic scanning light source array is controlled by a controller.

A novel holographic electric simulated flame generating device characterized in that a smooth light mixing layer is disposed on the light-diffusing plate.

A novel holographic electric simulated flame generating device characterized in that the controller comprises a data processor, a video processor and a data storage device; the data storage device stores content of program for displaying simulated flame; the data processor receives control commands from an interface circuit and then selects and executes corresponding program content that are preset and stored in the data storage device; the video processor converts the content selected to be executed by the data processor to control signals that drive the LED lights to display.

A novel holographic electric simulated flame generating device characterized in that the light-diffusing plate is made of glass or fiber reinforced plastics and a smooth light mixing layer is disposed thereon by sand blasting or glass etching.

A novel holographic electric simulated flame generating device characterized in that the light-diffusing plate and the electric circuit board are planer in shape.

A novel holographic electric simulated flame generating device characterized in that the LED lights are formed by mixing RGB colors or mono-color.

A novel holographic electric simulated flame generating device characterized in that the light-diffusing plate and the electric circuit board are curved in shape.

A novel holographic electric simulated flame generating device characterized in that the light-diffusing plate and the electric circuit board are all-rounded and encompassing 360 degrees.

A novel holographic electric simulated flame generating device characterized in that the LED lights are formed by mixing RGB colors or mono-color.

In comparison with the prior art, the present invention has the following advantageous effects: The present invention attains simulated flaming effects by a specially processed light-diffusing plate and programming control method. It generates simulated flames with strong three-dimensional sense and excellent sense of space and reality. It also has the advantages of being noiseless, low-voltage, low power consumption and low manufacturing costs. At the same time, the present invention is relatively simple in structure and therefore may be made lighter and thinner and then applied to a simulated flame apparatus as a flame generating device. As a result, the practical applications of the present invention are more diverse and human-oriented. It is widely applicable to people's daily life according to the concept of the products, and could create planar simulated flames, curved simulated flames and even 360 degrees encompassing three-dimensional flaming effect according to people's needs.

The present invention is further described with the accompanying drawings and various embodiments.

### BRIEF DESCRIPTION OF THE DRAWINGS

FIG. 1 is a front view of the first embodiment of the present invention.

FIG. 2 is a side view of FIG. 1.

FIG. 3 is a front view of the second embodiment of the present invention.

FIG. 4 is a top view of FIG. 3.

FIG. 5 is a schematic view of the third embodiment of the present invention.

FIG. 6 is a cross-sectional view along line A-A of FIG. 5.

FIG. 7 is a partial enlarged view of the area I of FIG. 6.

FIG. 8 is a schematic view of the cover of the third embodiment of the present invention.

FIG. 9 is a schematic view of the base of the third embodiment of the present invention.

FIG. 10 is a schematic view of the plastic ring of the third embodiment of the present invention.

FIG. 11 is a schematic view of the electric circuit connections of the third embodiment of the present invention.

FIG. 12 is a circuit diagram of the controller of the present invention.

### DETAILED DESCRIPTION OF THE INVENTION

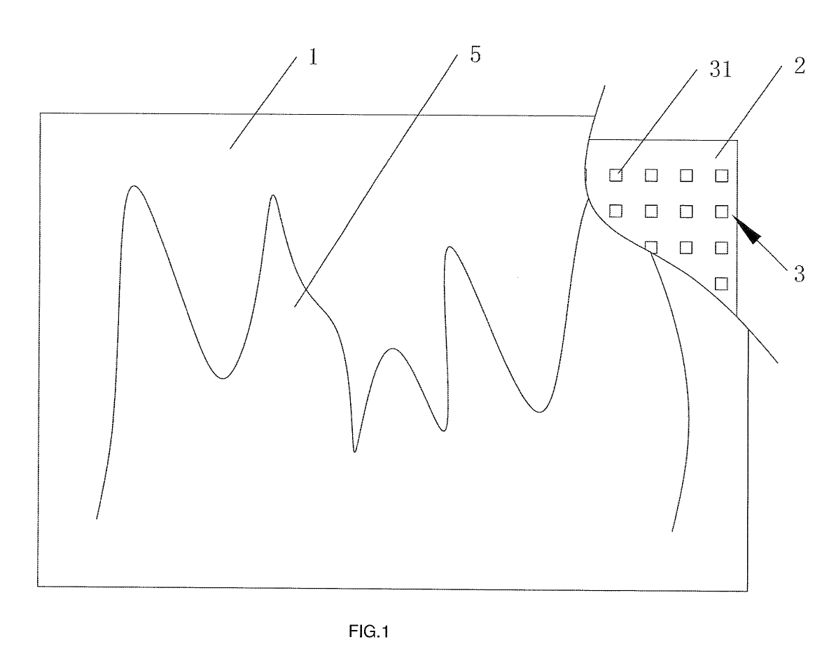

The present invention comprises a light-diffusing plate 1 and an electric circuit board 2 disposed behind the light-diffusing plate 1. A group of LED electronic scanning light source array 3 which irradiates directly upon the light-diffusing plate 1 is disposed on the electric circuit board 2. Each LED light 31 on the LED electronic scanning light source array 3 is controlled by a controller 4. The controller 4 may be disposed on the electric circuit board 2 or disposed independently from the electric circuit board 2. As shown in FIGS. 1-4, the controller is disposed at a rear side or a lateral side of the electric circuit board in the first and second embodiments respectively.

The present invention makes use of the LED array by having the controller 4 to control the LED lights to independently and simultaneously emit light at relative points and to display their brightness, grey level and color respectively. As such, lights generated from the LED lights in array arrangement irradiate upon the light-diffusing plate 1 like scanning to form a simulated flame. Under the modulation of the controller 4, each LED light 31 generates red, green, blue or mixed light with variable intensity. When the brightness of all LED electronic scanning light source array 3 varies simultaneously, a simulated flickering flame which resembles a real flame is produced. The light-diffusing plate 1 functions like a display screen through which people see the simulated flame 5 which has the visual effects of a real flame.

The light-diffusing plate 1 mainly prevents users from seeing clearly the individual LED lights or lights emitted therefrom, shades of other objects and so forth. In general, the light-diffusing plate 1 is coated with a smooth light mixing layer (either on a front surface or a rear surface), so that lights diffused and mixed by the light-diffusing plate 1 are more even. Further, by modulation of a program, the flaming effect is more realistic with a strong three-dimensional sense and an excellent sense of space and reality. The light-diffusing plate 1 may take the form of a transparent or semi-transparent plate made of frosted glass, glass, plastics, fabric, fiber reinforced plastics or other materials, and a smooth light mixing layer could be sprayed, painted or pasted thereon to create a simulated flame with three-dimensional spatial sense. In a preferred embodiment, the light-diffusing plate 1 is made of glass or fiber reinforced plastics and a smooth light mixing layer is disposed thereon by sand blasting or glass etching, thereby generating a more realistic flaming effect.

The controller 4 controls each LED light 31 to emit red, green, blue or mixed light with variable intensity in a regular manner, and produces a burning effect of the simulated flame 5 from bottom to top. As shown in FIG. 12, the controller 4 comprises a data processor 41, a video processor 42 and a data storage device 43. The data storage device 43 stores content of program for displaying the simulated flame. The data processor 41 communicates with external commands via wireless interface, network interface, infra-red interface or keyboard interface; it receives control commands from the interface circuit and then selects and executes the corresponding program content that are preset and stored in the data storage device 43. The video processor 42 converts the content selected to be executed by the data processor 41 to control signals that drive the display of the LED lights 31 so that the LED lights 31 are controlled independently to display their brightness, grayness and color respectively.

For example, in the circuit diagram as shown in FIG. 12, the data processor 41 may take the form of model number 3C44BOX, STC12C5412 and so forth. The video processor 42 may take the form of model number EP1K50QC208, EPM3128ATC100, LATTICE LFXP3C_TQ100 and so forth. The data storage device 43 may take the form of model number AM29LV640, AM29LV320, K4S641632F, KINGSTON 512 MB (CF card). The network interface may take the form of RTL8019AS. The wireless interface may take the form of a wireless communication module under model number SRWF-508. The infra-red interface may take the form of RT1021B. The keyboard interface may take the form of STC12C5412. The LED display driver chip may take the form of model number TBA62726AF.

Each LED light 31 may be formed by mixing RGB colors. When programming the controller 4, the light intensity output for red, green and blue lights emitted by each LED light may be adjusted as desired. The mixing of the three colors could simulate the color effect of a particular section of a flame. For example, the centroid of a flame (corresponding to the LED lights located at a lower part of the generating device) should be the brightest, but further away from the centroid (corresponding to the LED lights located at an upper part of the generating device) the flame should gradually be paler and weaker. When mono-color, such as red, green or blue LED lights 31 are used, the LED light array should be arranged on the electric circuit board from bottom to top in such a way that LED lights of different colors should be positioned according to the desired flame size and flaming effect so that lights emitted by adjacent LED lights could be mixed to create burning effect that resembles different sections of a flame.

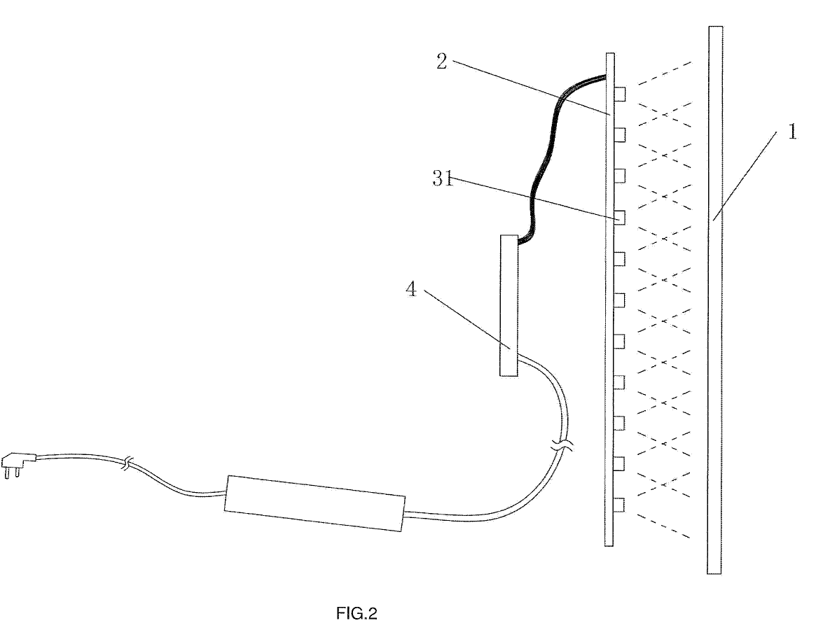

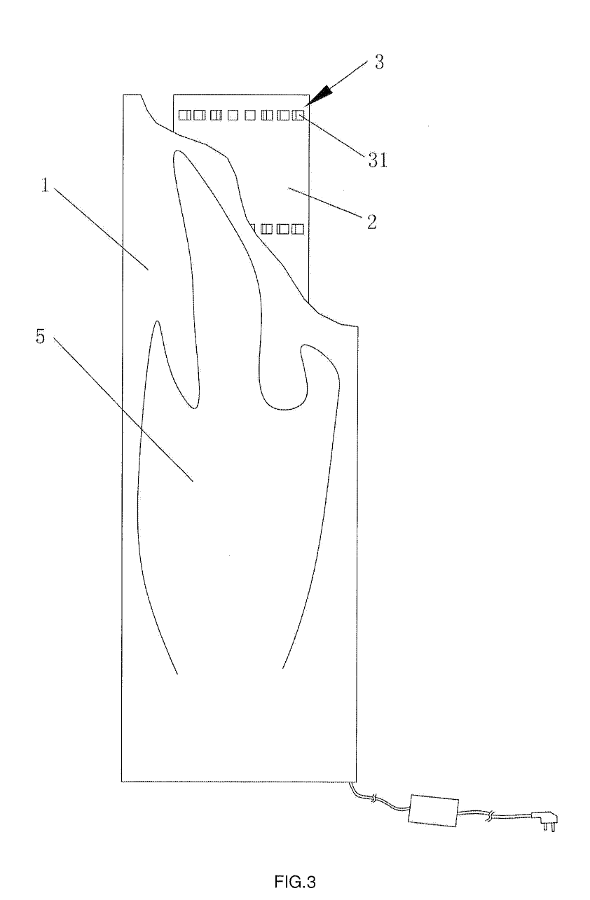

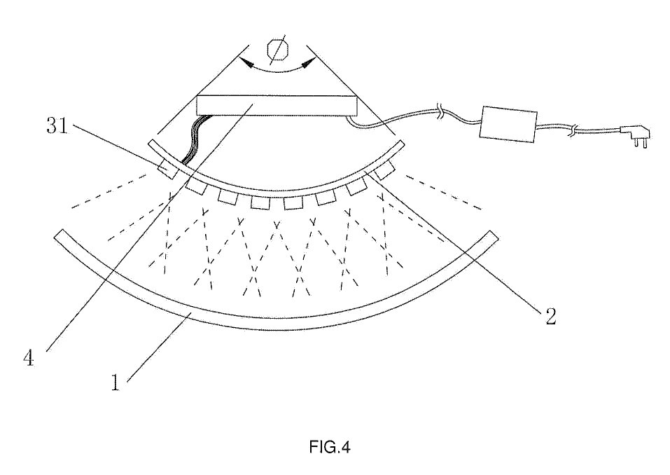

The first embodiment as shown in FIGS. 1 and 2 is a planar flame generating device wherein the light-diffusing plate 1 and the electric circuit board 2 are planer in shape. The second embodiment as shown in FIGS. 3 and 4 is a curved flame generating device wherein the light-diffusing plate 1 and the electric circuit board 2 are curved in shape. The angle of curvature φ as shown in the figures could be adjusted between 0-360 degrees depending on practical applications. Moreover, the light-diffusing plate 1 and the electric circuit board 2 may be in shape of wave, cone and so forth, and they could be either parallel or non-parallel with respect to each other.

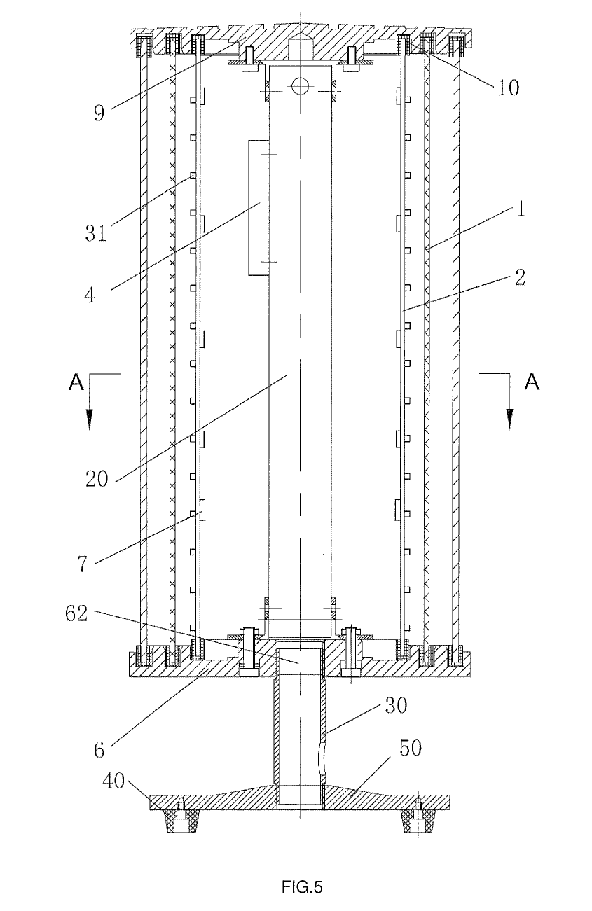

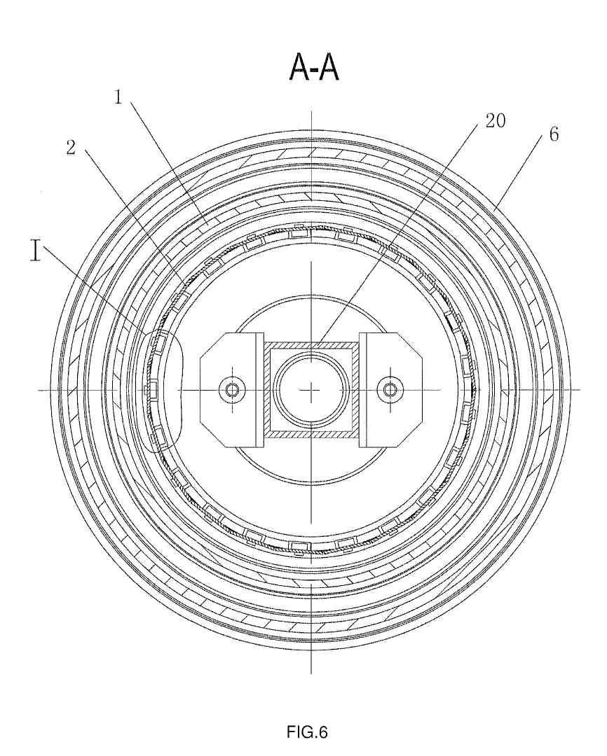

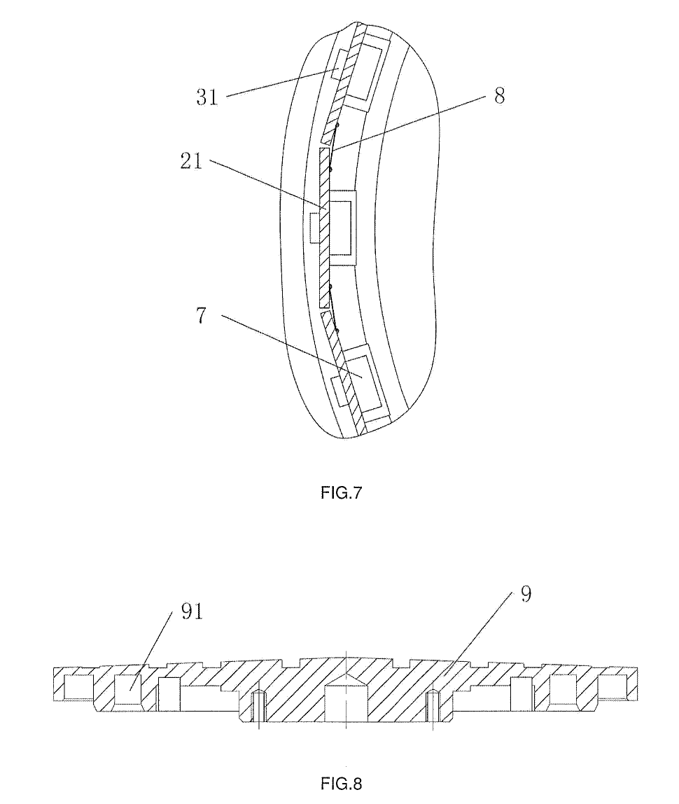

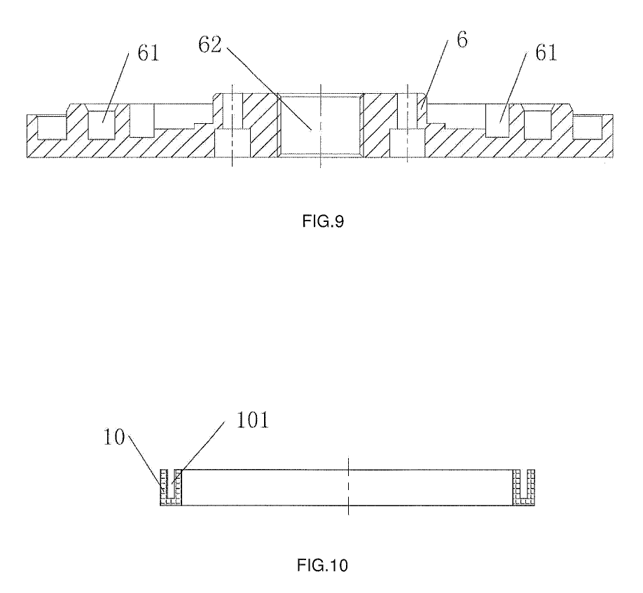

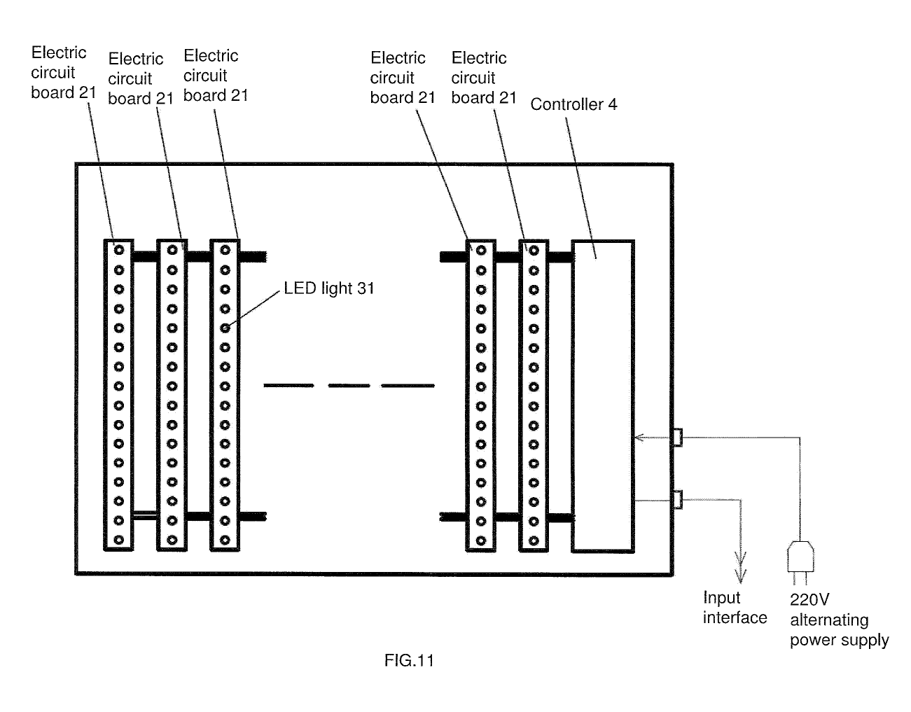

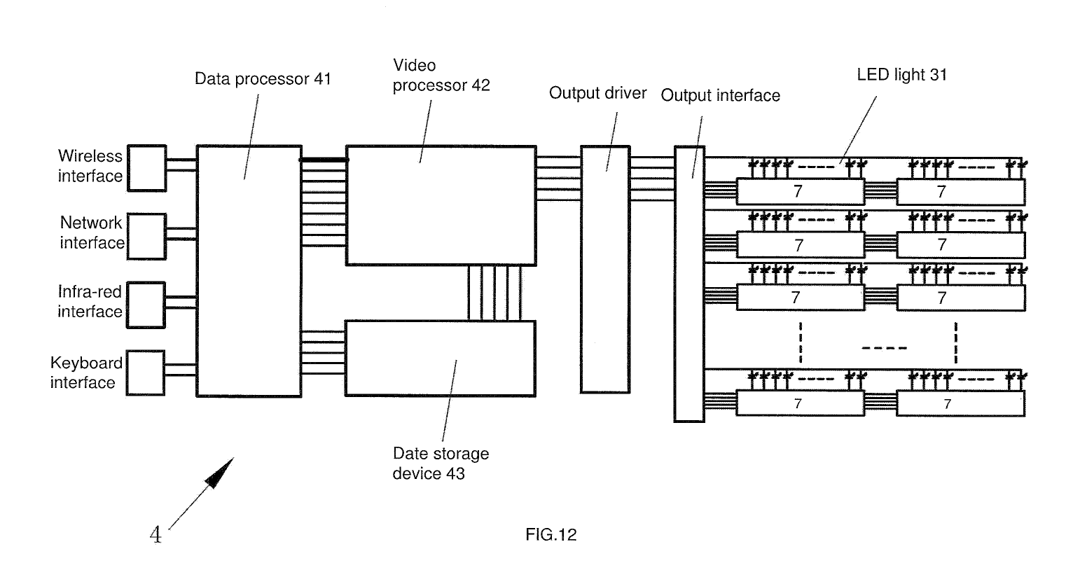

When the light-diffusing plate 1 and the electric circuit board 2 form an angle of 360 degrees, their cross sections are all-rounded and form a 360 degree encompassing square, circle or other shape. In this case, the simulated flame could be observed from all directions in 360 degrees, and the present invention may be in shape of a cylinder, a prism, a cone, a pyramid and so forth. The embodiment as shown in FIGS. 5-11 is a flame generating device in shape of a cylinder. The light-diffusing plate 1 and the electric circuit board 2 are both in shape of a cylinder which opens at its top and its bottom. The light-diffusing plate 1 and the electric-circuit board 2 are securely disposed on a base 6, and a cover 9 could be disposed to the top. The cover 9, the light-diffusing plate 1 and the base 6 therefore encompass the electric circuit board 2. On the side of the electric circuit board 2 which faces the light-diffusing plate 1, the electric circuit board 2 is disposed with a plurality of LED lights 31 all-around (i.e. over 360 degrees), and a LED display driver chip 7 is disposed on the electric circuit board 2 to drive independent operation of each LED light 31. The electric circuit board 2 may take the form of a soft electric circuit board which is processed to form a closed cylinder, prism or other shapes. In the present embodiment, the electric circuit board 2 comprises 21 strip-shaped electric circuit boards which form an electric circuit board in the shape of a closed 21-sided prism, with adjacent strip-shaped electric circuit boards securely connected with each other by welding of wires (as shown in FIGS. 6 and 7). The LED lights 4 are arranged regularly or randomly on the strip-shaped electric circuit boards 21. Each strip-shaped electric circuit board 21 may be disposed with an LED display driver chip 7 which is used to control the LED lights 31 on the strip-shaped electric circuit boards 21 to operate independently. The LED display driver chip 7 receives control signals from the controller 4, and the LED display driver chip 7 drives the brightness, grey level and color of each independently controllable LED light on the electric circuit board 2. The LED lights 31 on the electric circuit board 2 thereby generates flickering effect of a simulated flame from bottom to top; in other words, the color of the LED lights 31 at the lowest position resembles the color of the centroid of a flame, and the LED lights further away towards the top would be paler and weaker. When the lights emitted by LED lights are mixed together and processed by the light-diffusing plate 1, different dynamic three-dimensional flaming effects are generated under the control of the controller 4, thereby creating three-dimensional flaming effects resembling a real flame. The simulated flame with good three-dimensional visual effect could be observed from all directions in 360 degrees. In the present embodiment, the base 6 is disposed with a throughhole 62 so that all electric wires of the flame generating device could connect with external power sources and control wires via the throughhole 62 without affecting the overall outlook and appearance of the device. Besides, the present device may be securely connected to a base support 50 disposed with pivotal legs 40 via a connecting tube 30. The present device may then be designed as a lamp which is convenient to move and readily operable after connecting with a power source.

In the third embodiment, the base 6 and the cover 9 are each disposed with fixing grooves 61, 91 for fixing the electric circuit board 2 and the light-diffusing plate 1 in place. The fixing grooves 61, 91 are each disposed with a soft plastic ring 10 with an opening 101 for reliable installation and insulation. To install, the user first covers two ends of the electric circuit board 2 and the light-diffusing board 1 with the openings 101 of the soft plastic rings 101, and then inserts them to the corresponding fixing grooves on the base 6 and the cover 9. The light-diffusing plate of the present embodiment may also take the form of a spherical or ellipsoidal shape opened on one side, with the opened side facing the base 6 and covering the base 6. The controller 4 may be installed inside or outside the flame generating device. In the present embodiment the controller is installed inside the flame generating device and supported by a frame 20 inside the base. The frame 20 connects the base 6 and the cover 9 so as to strengthen the structure of the flame generating device.

In conclusion, the present invention attains simulated flaming effects by a specially processed light-diffusing plate and programming control method. It generates simulated flames with strong three-dimensional sense and excellent sense of space and reality. It also has the advantages of being noiseless, low-voltage, low power consumption and low manufacturing costs. At the same time, the present invention is relatively simple in structure and therefore may be made lighter and thinner and then applied to a simulated flame apparatus as a flame generating device. As a result, the practical applications of the present invention are more diverse and human-oriented. It is widely applicable to people's daily life according to the concept of the products, and could create planar simulated flames and 360 degrees encompassing three-dimensional flaming effect according to people's needs, such as flame light for landscape, light for bar table, electric fireplace with flames, stage backdrop with flaming effect and flame stage props, torch wall lamp, electric fireplace, household decorative lights related to flames, flame light box for advertisement and so forth which are all related to the theme related to flames.

I claim:

1. A novel holographic electric simulated flame generating device, characterized in that it comprises a light-diffusing plate (1) and an electric circuit board (2) disposed behind the light-diffusing plate (1); a group of LED electronic scanning light source array (3) which irradiates directly upon the light-diffusing plate (1) is disposed on the electric circuit board (2); each LED light (31) on the LED electronic scanning light source array (3) is controlled by a controller (4).

2. A novel holographic electric simulated flame generating device as in claim 1, characterized in that a smooth light mixing layer is disposed on the light-diffusing plate (1).

3. A novel holographic electric simulated flame generating device as in claim 2, characterized in that the controller (4) comprises a data processor (41), a video processor (42) and a data storage device (43); the data storage device (43) stores content of program for displaying simulated flame; the data processor (41) receives control commands from an interface circuit and then selects and executes corresponding program content that are preset and stored in the data storage device (43); the video processor (42) converts the content selected to be executed by the data processor (41) to control signals that drive the LED lights (31) to display.

4. A novel holographic electric simulated flame generating device as in claim 2, characterized in that the light-diffusing plate (1) is made of glass or fiber reinforced plastics and a smooth light mixing layer is disposed thereon by sand blasting or glass etching.

5. A novel holographic electric simulated flame generating device as in claim 4, characterized in that the light-diffusing plate (1) and the electric circuit board (2) are planer in shape.

6. A novel holographic electric simulated flame generating device as in claim 4, characterized in that the LED lights (31) are formed by mixing RGB colors or mono-color.

7. A novel holographic electric simulated flame generating device as in claim 4, characterized in that the light-diffusing plate (1) and the electric circuit board (2) are curved in shape.

8. A novel holographic electric simulated flame generating device as in claim 7, characterized in that the light-diffusing plate (1) and the electric circuit board (2) are all-rounded and encompassing 360 degrees.

9. A novel holographic electric simulated flame generating device as in claim 8, characterized in that the LED lights (31) are formed by mixing RGB colors or mono-color.
